(19) United States
(12) Patent Application Publication
(10) Pub. No.: US 2006/0130525 A1
(43) Pub. Date: Jun. 22, 2006

(54) Device and process for producing a glass tube

(76) Inventors: Frank Buellesfeld, Frankfurt am Main (DE); Markus Riedl, Mitterteich (DE); Paul Kissl, Mainz (DE)

Correspondence Address: STRIKER, STRIKER & STENBY, 103 EAST NECK ROAD, HUNTINGTON, NY, 11743, US

(21) Appl. No.: 11/296,772

(22) Filed: Dec. 7, 2005

(30) Foreign Application Priority Data
Dec. 14, 2004 (DE) 10 2004 060 408.8

(51) Int. Cl. C03B 17/04; C03B 29/00; D02G 3/00

(52) U.S. Cl. 65/108; 65/187; 65/68; 428/398

(57) ABSTRACT

The invention relates to a device and a process for producing a glass tube, preferably continuously.

The device comprises a shaft (9) into which a glass melt is introduced, so that the outer profile of the glass tube (1) is determined at least in sections by the shaft, and a shaping means (10), which extends coaxially in the interior of the shaft, for determining the inner profile of the glass tube (1). The shaping means (10) is cooled and the shaft is disposed vertically. The glass melt is cast freely into the shaft (9) while forming a free meniscus. According to the invention, the shaping means (10) is cooled so that the glass melt solidifies in the shaft to form the glass tube (1). The glass passes through the temperature range which is critical for crystal formation within a very short time, so that precise glass tubes can also be produced from readily crystallising glasses. It is also possible to precisely shape glass tubes with any desired inner and/or outer profiles. Glass tubes with a comparatively low ratio of outside diameter (OD) to wall thickness (WT), in particular with a ratio OD/WT of lower than approximately 0.1*OD/[mm], can be produced by redrawing.

### FIELD OF THE INVENTION

The invention relates to a device and a process for producing glass tubes, in particular by means of a continuous process.

### BACKGROUND OF THE INVENTION

Defined glass tubes are generally produced by drawing processes. A distinction is made in this respect between so-called Danner processes, Vello processes and downdraw processes. The outside diameter (OD) and wall thickness (WT) ratio (OD/WT) is limited in all drawing processes. The minimum value which can be achieved depends on the OD and on the density (ρ) of the glass. As soon as the quotient ODρ/WT exceeds a critical value k, it is no longer possible to shape out a stable drawing bulb, as the own weight of the molten glass is too high. In this case the value of k is dependent on OD, with k increasing in particular with OD. The drawing processes which are known from the prior art are therefore limited to comparatively high outside diameter to wall thickness ratios (OD/WT). For illustration purposes FIG. 2 shows common geometries which can be achieved with the above-mentioned conventional drawing processes. These essentially lie above a line which can be described by the function OD/WT=0.1*OD/[mm], wherein OD and WT indicate the outside diameter (OD) and the wall thickness (WT), respectively, of the glass tube in millimetres. This function is indicated in FIG. 2 by a line which has been aligned through the data points which are defined on the basis of the squares. As can be seen from FIG. 2, the above-mentioned relation applies in particular to OD>50 mm in the above-mentioned conventional drawing processes.

A further limitation of the drawing processes lies in a possible susceptibility to crystallisation of the glass. Because of the relatively high viscosity, which is necessary for drawing, the glass is cooled very slowly through the range which is critical for crystallisation, so that crystals may form in the glass. This means that the above-mentioned drawing processes cannot be freely applied to all glasses.

Moreover, there is an increasing requirement for industrial tubes of geometries other than circular. For example, non-circular geometries are required in the field of SMD (surface-mounted design). On account of the sometimes highly special and close-tolerance geometries, although it is in this case basically possible and also usual to produce the tubes from the melt, this entails a significant non-recurring expenditure to achieve the geometry, in particular where small and medium batch sizes are concerned.

EP 0 474 919 A1 discloses a batch process for producing tubular glass preforms in which a column of a liquid core glass flows into a bath of a sheath glass melt and the core glass and the sheath glass are cooled, while preventing the occurrence of crystallisation and mixing of the two glass melts. It is not possible to extend the process to the continuous production of glass tubes.

JP 57-183332 A discloses a process for producing a fluoride glass tube as a sheath of a glass fibre preform. In the process a graphite tube is disposed in the centre of a cylindrical casting mould, and a glass composition is cast into the mould, this forming a glass tube with the graphite tube contained therein following cooling. The graphite tube is then converted in a controlled manner into gaseous combustion products until finally the fluoride glass tube remains. This process is comparatively complex and is not suitable for the continuous production of glass tubes.

GB 766,220 discloses a process for the continuous production of glass tubes in which a molten material is continuously fed to a rotating centrifuge drum, where the glass tubes are formed through centrifugal forces and subsequently drawn out of the basket. A calibrated die may be disposed between the drum and the drawing device to calibrate the profile of the glass tube. This die must also be rotated in synchronism with the basket, which is a complex procedure.

U.S. Pat. No. 4,519,826 discloses a process for producing glass fibres in which a sheath tube is cast under the action of centrifugal forces, after which a core glass melt is introduced into this sheath tube in order to form a glass preform, following which the preform is drawn to form a glass fibre. This process does not therefore relate to the production of glass tubes.

A related shaft casting device for the continuous production of solid glass rods is known from DD 0 154 359.

U.S. Pat. No. 4,546,811 discloses a device for enabling a melt to be treated or processed without this contacting the walls of a vessel, which could otherwise give rise to impurities in the melt. For this purpose at least one gas-permeable wall of a porous or perforated material is provided, through which material the gas is forced under pressure in order to produce on the surface of the wall a gas film which supports the melt and thus prevents direct contact between the melt and the wall. This procedure is intended in particular for crystal pulling processes.

U.S. Pat. No. 3,523,782 discloses another related device for producing a glass tube with a shaft and a shaping means, which extends coaxially in the interior of the shaft and is formed: as a drawing mandrel, for determining the inner profile of the glass tube. The shaft extends obliquely, so that the glass melt flows obliquely onto a rear end of the drawing mandrel. In order to start the process, the melt flows to an outlet opening of the shaft and is withdrawn at this point from the shaft by a gatherer along the direction of the shaft. The drawing mandrel is cooled in the process. The glass tube is, however, not cooled to a temperature below the softening temperature of the glass until it has emerged from the lower end of the shaft. In order to prevent uncontrolled squashing of the glass tube, which is still viscous, in the shaft after leaving the shaping means, complex measures have to be taken to equalise the pressure or apply an overpressure in the interior of the tube, so that the process as a whole becomes complex. It is in particular impossible to accurately produce in this way homogeneous glass tubes with a comparatively low ratio of outside diameter to wall thickness.

### SUMMARY OF THE INVENTION

The object of the present invention is to provide a device with which homogeneous glass tubes with a comparatively low ratio of outside diameter to wall thickness can be accurately produced. According to a further aspect of the present invention, a device of this kind is to produce glass tubes having in particular a ratio of outside diameter (OD) to wall thickness of less than approximately 0.1*OD/[mm] in the convention illustrated above on the basis of FIG. 2. According to a further aspect of the present invention, a corresponding production process is to be provided.

The present invention provides a device for producing a glass tube, in particular for the continuous production of a glass tube, with a shaft into which a glass melt can be introduced, in particular cast, so that the outer profile of the glass tube is determined at least in sections by the shaft, and with a shaping means, which extends coaxially in the interior of the shaft, for determining the inner profile of the glass tube, wherein the shaping means is cooled, so that the glass melt solidifies in the shaft to form the glass tube.

A shaft within the meaning of the present invention is in particular formed as a tall, comparatively narrow tubular structure of an appropriate cross section which is adapted to the profile of the glass tube which is to be produced. The shaft preferably extends substantially vertically, i.e. in the direction of the force of gravity, so that a uniform, symmetrical flow profile of the glass melt is formed in the shaft, which results in advantageously low levels of distortion and other faults in the glass tube. A shaft of this kind within the meaning of the present invention preferably comprises at its upper end an opening into which the molten glass can be freely cast without having to come into contact with an inner circumferential wall of the shaft. At the lower end of a shaft of this kind there is a further opening out of which the glass tube which has already solidified leaves the shaft, for example is carried off or withdrawn. Since—because the shaft is disposed vertically—the glass tube directly follows the force of gravity, the risk of the glass tube bending is minimised, which enables highly homogeneous glass tubes to be produced according to the invention.

The molten glass can be cast into the shaft such that at least an upper section of the shaft is substantially completely filled by the molten glass in order to determine the outer profile of the glass tube. For this purpose the molten glass can lie at least in sections against the inner circumferential wall of the shaft or flow nearly up to this in order to determine the outer profile of the glass tube. As the outer profile of the glass tube is therefore essentially determined by the cross section of the shaft, the invention enables the glass tube to be shaped in a relatively free manner.

The molten glass can in this case flow or be cast freely into the shaft, i.e. while forming a free meniscus, from a melting channel, a melting tank or a glass melt vessel. According to the invention, the molten glass is supported by the glass tube which has already sufficiently solidified in the lower or downstream section of the shaft such that there is no possibility of the molten glass flowing through the shaft in an uncontrolled manner. The afterflowing glass melt is therefore constantly sufficiently supported while the glass tube is withdrawn from the shaft at a predeterminable withdrawal speed. However, unlike the case of the above-mentioned conventional drawing processes, the withdrawal of the glass tube does not fulfil the function of drawing the conventional bulb to form a glass tube.

According to the invention, an additional, cooled shaping means for determining the inner contour is disposed in the shaft coaxially with the latter. The shaping means may be formed as an elongated mandrel with an appropriate profile, for example circular, triangular, polyhedral, also tapering in the longitudinal direction, and is sufficiently cooled according to the invention so that the molten glass is cooled at the front or downstream end of the shaping means to a temperature which expediently lies below the softening temperature of the glass, which means that the glass tube is already sufficiently solidified at the front end of the shaft and is essentially not deformed further. When it leaves the shaping means the glass has therefore already solidified such that no further viscous deformation occurs downstream of the shaping means. Because the glass tube which has already solidified at the front end of the shaft is comparatively stable, the glass tube cannot be flattened or squashed in an undesirable manner upon leaving the shaft. A further advantage lies in the fact that expensive measures for generating an overpressure in the interior of the tube or for ventilating the interior of the tube, as are required in the prior art, are not necessary according to the invention for preventing undesirable flattening or squashing of the glass tube as it leaves the shaft.

In this case the profile of the shaping means can be formed so as to correspond to the profile of the shaft, or the shaft and the shaping means can have different profiles. Glass tubes can therefore be shaped with even greater freedom according to the invention.

According to the invention, a fluid coolant, for example a gas, a liquid such as, for example, water or a gas-liquid mixture can flow through the shaping means for cooling purposes in order to cool the shaping means. The shaping means can of course also be in thermal contact with a cooling finger or similar in order to carry off the heat of the shaping means and to predetermine appropriate temperature conditions at the shaping means.

The process according to the invention enables the glass tube to be shaped relatively freely, in particular through simple casting, preferably by casting the glass melt freely into the shaft, so that the glass melt is formed by the shaping means into a glass tube with an inner profile which is defined by the shaping means. It is therefore not imperative according to the invention to draw the glass tube. The glass melt can rather be introduced into the shaft with a comparatively low viscosity or high flow speed. In this respect the glass melt or glass tube passes through the shaft comparatively quickly, so that the glass is as a result less susceptible to crystallisation, with fewer crystals therefore forming in the glass.

In contrast to the above-mentioned conventional processes of drawing from the melt, in which there is always direct and, as a rule, adhesive contact with a drawing die and an inner needle, which usually leads to the formation of a characteristic speed profile through the glass cross section and to minimum values at the points of contact with the needle and with the die, according to the invention the speed profile and the flow movement of the glass melt or of the—still viscous—glass tube can be significantly evened out. The speed profile in particular changes to a lesser degree following detachment from the front edge of the shaping means, which results in advantageously homogeneous and precise glass tubes. According to the invention, the more uniform speed profile and the less complex flow movement result in significantly fewer deviations of the geometry of the glass tube from the geometry of the shaft and shaping means, even irrespective of surface tension influences.

In contrast to the above-mentioned conventional drawing processes, according to the invention it is also unnecessary for the die to be of a complex geometry in order to observe exacting specifications. Even complicated and precise internal geometries (for example narrow edge radii, significant internal indentations inwards) can be produced according to the present invention in a simple and inexpensive manner.

Because no bulb is formed in the process according to the invention, glass tubes with comparatively thick walls or with a comparatively low ratio of outside diameter (OD) to wall thickness (WT) can be formed according to the invention. The above-mentioned instabilities of the bulb are therefore avoided.

According to a further embodiment, the shaft can be moved relative to the intake for the molten glass. It is also possible for the glass tube to be rotated relative to the shaft in order to obtain circular outer profiles.

According to a further embodiment of the present invention, the shaft is designed such that a gas cushion is formed on an inner circumferential wall of the shaft in order to prevent direct contact between the inner circumferential wall of the shaft and an outer circumferential wall of the glass tube, at least in sections.

Because the gas cushion prevents the glass melt from directly contacting the wall material of the shaft, the glass tube can be produced with advantageously few impurities. Because the gas cushion prevents the glass melt from directly contacting the wall material of the shaft, the glass tube can be produced with a comparatively high mass flow rate, which reduces production costs. The gas cushion is in this case preferably formed with a comparatively small thickness of, for example, a few tenths of a millimetre, so that the outer profile of the glass tube is substantially determined directly by the cross section of the shaft. Glass tubes can therefore be produced highly precisely with predefined outer profiles according to the invention.

According to a further embodiment, the device comprises an overpressure generating means in order to form the gas cushion at the inner circumferential wall of the shaft with an overpressure. The gas cushion gives rise to a restoring force which acts on the outer circumferential wall of the glass tube and uniformly pushes this inwards or deforms it. If the shaft has a circular cross section, for example, the outer circumferential wall is pushed radially inwards in a uniform manner, so that a glass tube with a circular outer profile is automatically produced. Glass tubes with highly uniform, smooth outer surfaces can therefore be formed according to the invention.

According to a further embodiment, the circumferential wall of the shaft located in the pressure vessel is formed at least in sections from a porous material, so that a gas can pass through the circumferential wall into the interior of the shaft in order to generate the overpressure of the gas cushion.

According to a further embodiment, the overpressure generating means comprises a pressure vessel which holds the shaft. A gap is in this case formed between an inner wall of the pressure vessel and the outer wall of the shaft, which gap can be filled with a flushing gas under an overpressure. If a porous shaft material is used, the gap communicates with the inner circumferential wall of the shaft, so that the gas cushion can be formed on the inner circumferential wall of the shaft.

According to a further embodiment, a flushing gas, for example nitrogen, argon or an inert protective gas, continuously flushes through the pressure vessel, the pressure vessel comprising at least one flushing gas inlet and at least one flushing gas outlet which communicate with the inner circumferential wall of the shaft and are designed to adjust the overpressure of the gas cushion through the inflow of a flushing gas into the pressure vessel. In this respect the overpressure can be appropriately predetermined through an appropriate choice of gas flow cross sections. The gas serves to cool the shaft and to protect the shaft material against oxidation.

At least one flushing gas outlet of the pressure vessel can be at least partly closed in order to adjust the overpressure of the gas cushion.

The shaping means is preferably disposed concentrically in the shaft, in which case the glass tube is provided with a centrosymmetrical inner profile. The shaping means can of course also be disposed coaxially in the shaft in a manner other than concentric.

According to a further embodiment, the shaping means is formed as an elongated mandrel which preferably tapers continuously in the glass withdrawal direction, the diameter of the mandrel at a downstream, lower end therefore being smaller than that at an upstream, upper end. The shaping of the mandrel enables the separation of the glass melt from the front end of the mandrel to be precisely predetermined. The mandrel may be of a conical shape, in which case the glass tube can also be rotated about its longitudinal axis when withdrawn from the device. The mandrel may of course also have a non-circular cross-sectional geometry, in which case the glass tube can also be shaped without being rotated about its longitudinal axis.

According to a further embodiment, a further gas cushion is formed on an outer circumferential wall of the shaft, in particular of the elongated mandrel, as described above, which cushion is preferably under a certain overpressure with respect to the environment, in order to prevent direct contact between the inner circumferential wall of the glass tube and the outer circumferential wall of the shaping means, at least in sections. One advantage lies in the fact that the glass melt can pass through the shaft with an even lower flow resistance, which advantageously helps to form glass tubes of an even more uniform shape. A further advantage lies in the fact that the possibility of the gas cushion thickness being predetermined by the overpressure provides a further parameter for easily and appropriately adjusting the temperature conditions when the glass melt solidifies and/or when the glass tube is shaped. Because direct contact between the inner profile and the shaping means is prevented, the inner profile can also be formed in a highly uniform manner, for the gas cushion pushes the wall material of the glass tube or the glass melt uniformly outwards, in the case of a circular profile radially outwards, for example.

In order to adjust the gas cushion on the outer circumferential wall of the shaping means, a flushing gas inlet may be associated with the shaping means or the shaping means may comprise a porous material or be formed from this, at least in sections.

The shaft of the device represents as a whole an elongated, comparatively slender hollow body, i.e. a hollow body with a comparatively low opening width-to-length ratio, which is preferably distinctly lower than 1, for example in the range between approximately ⅓ and 1/33.

This shaft may have a circular or an elliptical cross section. However, because according to the invention the glass tube can be cast, the shaft may also have any other non-circular cross-sectional geometry, for example a triangular, square, rectangular or polygonal cross-sectional geometry. Glass tubes with any desired outer profiles can therefore be formed precisely and uniformly according to the invention.

According to the invention, the cross-sectional geometry of the shaft may of course be combined with any desired profiles of the shaping means, so that glass tubes with any desired inner and outer profiles can therefore be formed precisely and uniformly.

According to a further embodiment, the device comprises a closure element (starter), which is adapted to a shape of the glass tube, in order temporarily to close the shaft and to prevent glass from flowing through the shaft in an uncontrolled manner, for example when the device is started up. The closure element is disposed so as to be longitudinally displaceable in the shaft and, after it has been lowered, can be removed from the shaft in order to start the continuous formation of glass tubes.

According to a further aspect of the present invention, a process for producing a glass tube, in particular a continuous production process, is also provided, in which a molten glass is cast into a shaft in order to determine the outer profile of the glass tube and flows over a shaping means, which extends coaxially in the interior of the shaft, in order to determine the inner profile of the glass tube, wherein the shaping means is cooled, so that the glass melt solidifies in the shaft to form the glass tube.

The molten glass can be cast into the shaft at a temperature which corresponds to a viscosity of less than 10^{7.5} dPas, more preferably a viscosity in the range from 10 dPas to 10⁵ dPas and even more preferably a viscosity in the range from 10² dPas to 10⁵ dpas, i.e. overall significantly lower than in the case of the above-mentioned—known conventional drawing processes. Here the molten glass is cooled at the shaping means to a temperature below the softening temperature of the glass, so that the glass tube appropriately supports the molten glass flowing after into the shaft in order to prevent the afterflowing molten glass from flowing through the shaft in an uncontrolled manner.

It is thus possible, in a simple and inexpensive manner, to form advantageously homogeneous and precise glass tubes with comparatively high wall thicknesses, as the wall thickness when casting the glass tube according to the invention is no longer limited by the bulb and the drawing parameters of conventional drawing processes. The fact that according to the invention the glass melt is of a distinctly lower viscosity in comparison with the prior art when it is cast into the shaft enables the shaft to be filled in a highly homogeneous manner, which, according to the invention, enables highly homogeneous glass tubes to be produced.

According to a preferred aspect of the present invention, it is in particular possible to form a glass tube with a ratio of outside diameter (OD) to wall thickness (WT) which is lower than or equal to 0.1*OD/[mm], wherein OD and WT are to represent, in the convention explained in detail above on the basis of FIG. 2, magnitudes which are to indicate the outside diameter (OD) and the wall thickness (WT), respectively, of the glass tube in millimetres in each case. Here the outside diameter of the glass tube may be greater than or equal to 40 mm.

According to a further aspect of the present invention, a glass tube which is thus produced with an appropriate inner and outer profile can be used as a preshaped starting material or preform for producing a glass tube with a smaller outside diameter by conventional redrawing.

In contrast to conventional glass tube drawing processes, such as, for example, Danner processes, Vello processes and downdraw processes, surface tension effects as well as flow dynamic effects, which occur when using conventional drawing dies, are of comparatively little significance when redrawing. This means that a great number of various geometries of the glass tubes are possible according to the invention; these include geometries with sharp corners as well as geometries with particularly distinctive convex indentations on the inside. For, in contrast to the conventional processes of drawing directly from the melt, the redrawing is not dependent on a comparatively low drawing viscosity, for example on a drawing viscosity of approximately 10⁴ dpas. According to the conventional drawing processes, the glass can still be deformed extremely easily at this viscosity, which usually results in the glass attempting to assume a minimum surface (circular cross section). Sharp edges are therefore considerably rounded, even if they are provided in the die or needle geometry, in the conventional drawing processes. In contrast to this, glass tubes with comparatively sharp corners or edges can be achieved according to the invention. Moreover, according to the invention the indentations of the glass tube are deformed to a lesser extent inwards on the inside of the tube than outwards, so that susceptibility to the formation of a largely circular inner space is effectively reduced according to the invention.

It is also possible to shape the tube during the redrawing step by introducing one or more forming roll(s) into the deformation region of the tube. It is thus possible, for example, to obtain oval or even rectangular tubes from circular preform tubes.

The cast glass tube may in this respect be clamped in a retaining and/or drawing device, partially heated and then drawn to the desired outside diameter or the desired dimension.

Glass tubes which are redrawn in this way can be used for technical applications, for example as electromagnetic components, in particular as so-called reed switches, in the known manner.

As is immediately obvious from the above description, a further advantage of the device according to the invention and of the process lies in its high flexibility. The cast tubes can thus be produced at different tanks with different glasses. These tubes of standard dimensions can then be drawn or redrawn to the final geometry within a very short time according to customer specifications. Short delivery periods are thus possible.

### SUMMARY OF THE DRAWINGS

The invention is illustrated in the following by way of example and with reference to the accompanying drawings, from which further features, advantages and objects to be solved emerge and in which:

FIG. 1 represents in a cross section a device for producing glass tubes according to an embodiment of the present invention; and

FIG. 2 compares in a schematic diagram glass tubes which are produced by means of a conventional drawing process with glass tubes which are produced according to the present invention.

### DETAILED DESCRIPTION OF PREFERRED EMBODIMENTS

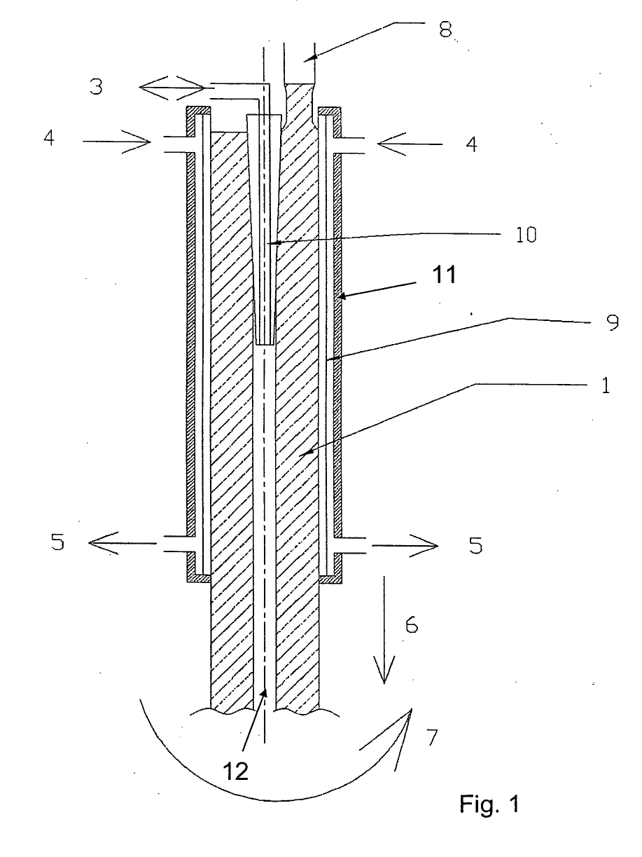

According to FIG. 1, the device comprises an elongate and comparatively slender shaft 9 which preferably extends in the direction of the force of gravity, i.e. vertically, as well as a mandrel 10 which acts as a shaping means, is located in the interior of the shaft and extends coaxially with the shaft 9. The shaft wall preferably comprises a material which is stable under high temperatures, for example graphite, white metal, SiC and/or steel.

According to FIG. 1, the shaft 9 is held in a pressure vessel 11, so that a flushing gas can be held in the annular gap between the shaft 9 and the inner circumferential wall of the pressure vessel 11 in order to surround the shaft 9.

A coaxial and concentric mandrel 10, which acts as a shaping means for determining the inner profile of the glass tube 1, is introduced into the shaft 9 centrally from the top. The mandrel 10 can be removed from the shaft 9, for example to start up the device. The mandrel 10 preferably comprises a material which is stable under high temperatures, such as, for example, graphite, white metal, SiC and/or steel or is formed from this. It is particularly preferable for the mandrel 10 to be a graphite mandrel. A coolant flows coaxially through the mandrel 10. Coolants may be, for example, a gas, a liquid such as water or a gas-liquid mixture.

According to FIG. 1, the mandrel is of a slightly conical configuration, with the lower or downstream diameter being smaller than the upper or upstream diameter. If the cone is too small, there may be a risk of the glass shrinking onto the mandrel and the process having to be stopped.

The circumferential wall of the shaft 9 may contain a porous material, so that the flushing gas can pass from the interior of the pressure vessel 11 through the circumferential wall of the shaft 9 in order to form a gas cushion on the inner circumferential wall of the shaft 9. The formation of a gas cushion by means of a porous wall material is described, for example, in U.S. Pat. No. 4,546,811, the content of which is to be explicitly included in the present application for disclosure purposes by reference. Porous material within the meaning of the invention may be porous graphite, porous metal, porous ceramics and other porous materials which are resistant to high temperatures.

According to an embodiment, the gas cushion prevents a direct contact between the glass or glass tube and the shaft material. The gas cushion is preferably formed with an overpressure. For this purpose flushing gas can flow continuously via the flushing gas inlets 4 into the pressure vessel 11 and the flushing gas outlets 5 can be at least partly blocked, so that a certain overpressure is generated in the pressure vessel 11 and is transmitted through the circumferential wall of the shaft 9 to the gas cushion.

The shaft 9 may in principle assume any shape. The shaft 9 is cylindrical shaft a glass tube with a circular outer profile is therefore formed.

According to FIG. 1, the molten glass is introduced into the shaft 9 from a melting channel, a melting tank or a comparable vessel or glass feed means (not illustrated) through a die 8 at the upper edge of the shaft 9. As represented schematically in FIG. 1, the molten glass can be cast freely into the shaft 9, so that a free meniscus can be formed below the die 8 and at the upper edge of the shaft 9, and the inflowing molten glass does not directly contact the inner circumferential wall of the shaft 9 during casting. The process is preferably carried out at the highest possible temperature in order to suppress cooling waves. However the temperature should also not be too high, as the glass is then not sufficiently solid after being removed from the mould and may be further deformed following shaping. When it is cast into the shaft 9 the glass melt is preferably at a temperature which corresponds to a viscosity of 10-10⁵ dPas, preferably 10² to 10⁵ dPas, and is therefore lower than a viscosity of approximately 10^{7.5} dpas, which corresponds to a softening temperature of the glass.

In order to start the process, a starter (not shown), which is adapted in terms of shape to the glass tube, may be used, this acting as a flat closure element for temporarily closing the shaft 9. This starter can be clamped in a rotation and displacement mechanism such that it projects into the shaft from below. This starter prevents the glass from flowing through the shaft without filling this at the beginning of the process, for example when the device is started up.

As soon as a sufficient glass film has formed on the starter, this is continuously lowered, so that the rising meniscus of the glass remains as constant as possible. As soon as the glass tube is of a sufficient length to be taken up from the feed and rotation mechanism, the starter can be removed, for example drawn out to the side. The process can then be operated continuously. The glass tube 1 passes through the shaft 9 in the feed direction which is indicated by the arrow 6. For this purpose it is not absolutely necessary to draw the glass out of the shaft 9, as is known from the prior art. According to a preferred embodiment, the glass tube is therefore not actively drawn out of the shaft, but rather simply transported away in an appropriate fashion. However, according to an alternative embodiment, the glass tube may also be actively drawn out of the shaft, for example to accelerate the process. As indicated by the arrow 7, where circular geometries are concerned, the glass tube 1 may also be continuously rotated about its longitudinal axis while the shaping described above is carried out.

During the production process glass continuously flows out of the feed pipe, which communicates with the die 8, onto the glass tube or rotating glass tube. The continuously produced tube can then be cut into segments of the desired length.

When using the process which is described here the glass passes through the temperature range which is critical for crystal formation and crystal growth in a very short time. It is therefore also possible to produce tubes from readily crystallising glasses with this process.

The application of the process is not restricted to circular cross-sectional geometries. For example, tubes of a rectangular or oval or any desired cross-sectional shape can also be produced using this process. However in this case the glass tube should not be rotated.

In this respect it is necessary to ensure during the process that the cross section of the shaft acting as a mould is filled as completely and uniformly as possible. This can also be achieved where non-circular cross-sectional shapes are concerned by giving the feeder or die 8 an appropriate shape or by a rotational and translatory movement of the shaft 9 and the cast tube 1.

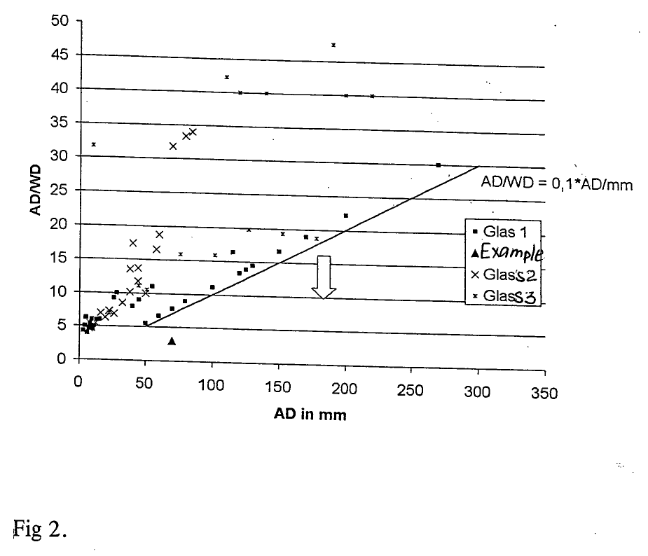

As indicated by the exemplary measuring point which is represented in FIG. 2 by the triangle, the process according to the invention enables glass tubes with OD/WT ratios of lower than approximately 0.1*OD/[mm] to be obtained, wherein OD and WT represent, in the convention introduced above on the basis of FIG. 2, magnitudes which indicate the outside diameter (OD) and the wall thickness (WT), respectively, of the cast glass tube in millimetres. Further series of tests carried out by the inventors, which are not represented in FIG. 2 for reasons of clarity, have confirmed this observation.

The glass tubes which are produced with the device according to the present invention are particularly suitable for use as preforms (appropriately preshaped starting materials) for producing tubes of a smaller diameter by means of an additional redrawing process. In this case a different OD/WT ratio (outside diameter to wall thickness) can also be set by means of a pressure difference between the inside of the tube and the outside of the tube.

Tubes with a smaller OD and an OD/WT ratio which is greater than or equal to the corresponding ratio of the preform can be produced from the tubes thus produced in a subsequent redrawing step. In order to achieve this, the cast glass tube is clamped in a retaining device, partially heated and then drawn to the desired diameter OD. The ratio OD/WT does not as a rule change as a result. However the ratio OD/WT can be influenced by pressurisation in the interior of the tube. It is thus possible, for example, to produce a glass tube with an OD/WT ratio which is greater than or equal to 0.1*OD/[mm] from a preform with OD/WT<0.1*OD/[mm] by means of an internal pressure pi which is higher than the external pressure pa.

### Examplary Embodiment

A conical graphite mandrel (outside diameter (OD) top=23 mm, OD bottom=18 mm) is introduced centrally into a slightly conical graphite shaft (inside diameter (ID) top=71 mm, ID bottom=72 mm) around which argon flushes. The graphite mandrel is mounted on a coaxially cooled holder of special steel. This is cooled by a mixture of air and atomised water. The SCHOTT 8250 glass is melted in a precious metal crucible. A precious metal pipe, which can be heated, is welded to the bottom of the crucible, this pipe opening into a die, which can also be separately heated. The parameters which are shown in Table 1 are set when the shaft is filled with the glass 8250. The results are represented in Table 2. A temperature of 1230° C. proves to be of advantage for the glass 8250 described in this example.

The tubes which are thus obtained are redrawn in a redrawing system. In this respect the outside diameter OD and the ratio OD/WT are set by means of the internal pressure and the drawing speed.

In a further embodiment the preform tube is produced as above. These are redrawn in a redrawing system. A new OD/WT ratio for the drawn tubes is set by means of the internal pressure. The product is then further shaped by means of two rolls in the deformation zone to form a rectangular tube. The rolls consist of hexagonal white metal or graphite in order to prevent damage to the surface of the glass tube.

TABLE 1
Parameters

| | | Test no. | | | | | |
|---|---|---|---|---|---|---|---|
| | | 1 | 2 | 3 | 4 | 5 | 6 |
| Crucible | ° C. | 1180 | 1180 | 1180 | 1180 | 1180 | 1180 |
| Pipe | ° C. | 1130 | 1150 | 1180 | 1200 | 1210 | 1230 |
| Die | ° C. | 900 | 920 | 950 | 970 | 980 | 1000 |
| Air (mandrel) | l/min | 150 | 150 | 150 | 150 | 150 | 150 |
| Water (mandrel) | l/min | 4 | 4 | 1.75 | 1.75 | 1.75 | 1.75 |
| Rotation | rev/min | 1.8 | 3.75 | 3.75 | 7.5 | 7.5 | 10 |
| Starter/glass tube | | | | | | | |

TABLE 2
Results

| | | Test no. | | | | | |
|---|---|---|---|---|---|---|---|
| | | 1 | 2 | 3 | 4 | 5 | 6 |
| Weight | g | 1622 | 1931 | 2005 | 3326 | 3675 | 3135 |
| Length | mm | 216 | 254 | 265 | 480 | 475 | 408 |
| OD max | mm | 69.4 | 69.5 | 69.6 | 69.6 | 69.7 | 67.9 |
| OD min | mm | 69.2 | 69.1 | 69.4 | 68.9 | 68.8 | 69 |
| ID (top) | mm | 23.9 | 22.4 | 24.6 | 21 | 21 | 20.8 |
| ID (bottom) | mm | 22 | 22.9 | 23.5 | 22.6 | 22 | 22.2 |
| WT(top) max | mm | 23.2 | 23.7 | 22.7 | 24.1 | 24.4 | 24 |
| WT(top) min | mm | 22.8 | 23.4 | 22.4 | 23.8 | 24.2 | 23.7 |
| WT(bottom) | mm | 23.7 | 23.5 | 23 | 23.6 | 24.2 | 23.9 |
| max | | | | | | | |
| WT(bottom) min | mm | 23.5 | 23.2 | 22.7 | 23.4 | 25 | 23.3 |
| Depth of cooling | mm | 1 | 0.6 | 0.2 | not | not | not |
| waves | | | | | measurable | measurable | measurable |
| external* | | | | | | | |
| Spacing of | mm | 12.1 | 6.5 | 8.2 | 3.6 | 4.4 | 2.8 |
| cooling waves | | | | | | | |
| external* | | | | | | | |
| Surface* | obscured/ | lustre | lustre | lustre | in the | in the | in the |
| | lustrous | | | | centre | centre | centre |
| | | | | | obscured, | obscured, | obscured, |
| | | | | | otherwise | otherwise | otherwise |
| | | | | | lustre | lustre | lustre |

What we claim is:

1. A device for producing a glass tube, in particular for the continuous production of a glass tube, with a shaft into which a glass melt can be introduced, so that the outer profile of the glass tube is determined at least in sections by the shaft, and with a shaping means, which extends coaxially in the interior of the shaft, for determining the inner profile of the glass tube, wherein the shaping means is cooled, wherein the shaft is disposed vertically, so that the glass melt can be cast into the shaft while forming a free meniscus, said shaping means being cooled so that the glass melt is cooled at the latter to a temperature below the softening temperature of the glass and the glass melt solidifies in the shaft to form the glass tube.

2. The device for producing a glass tube according to claim 1, wherein the shaft is designed such that a gas cushion is formed on an inner circumferential wall of the shaft in order to prevent direct contact between the inner circumferential wall of the shaft and an outer circumferential wall of the glass tube, at least in sections.

3. The device according to claim 2, having an overpressure generating means in order to form the gas cushion at the inner circumferential wall of the shaft with an overpressure.

4. The device according to claim 3, wherein the overpressure generating means comprises a pressure vessel for holding the shaft, wherein the pressure vessel comprises at least one flushing gas inlet and at least one flushing gas outlet which are designed to adjust the overpressure of the gas cushion through the inflow of a flushing gas into the pressure vessel.

5. The device according to claim 4, wherein at least one flushing gas outlet can be at least partly closed in order to adjust the overpressure of the gas cushion.

6. The device according to claim 2, wherein a circumferential wall of the shaft is formed at least in sections from a porous material, so that a gas can pass through the circumferential wall into the interior of the shaft in order to generate the overpressure of the gas cushion.

7. The device according to claim 1, wherein a coolant can flow through the shaping means in order to cool the shaping means.

8. The device according to claim 1, wherein the shaping means is formed as an elongated mandrel which is disposed concentrically in the shaft, wherein a diameter of the mandrel at a downstream, lower end is smaller than that at an upstream, upper end.

9. The device according to claim 8, wherein the mandrel is of a conical shape and/or has a non-circular cross-sectional geometry.

10. The device according to claim 8, wherein the mandrel is formed from a material which is resistant to high temperatures.

11. The device according to claim 1, wherein a flushing gas inlet is associated with the shaping means in order to form a gas cushion, which is preferably subject to an overpressure, between an inner circumferential wall of the glass tube and an outer circumferential wall of the shaping means and to prevent direct contact between the inner circumferential wall of the glass tube and the outer circumferential wall of the shaping means, at least in sections.

12. The device according to claim 1, wherein the shaping means comprises a porous material or is formed from this, at least in sections.

13. The device according to claim 1, wherein the shaft has a non-circular cross-sectional geometry.

14. The device according to claim 1, further comprising a closure element, which is adapted to a shape of the glass tube, in order to temporarily close the shaft and to prevent glass from flowing through the shaft in an uncontrolled manner, wherein the closure element is disposed so as to be longitudinally displaceable in the shaft and, after it has been lowered, can be removed from the shaft.

15. A process for producing a glass tube, in which process a molten glass is cast into a shaft in order to determine the outer profile of the glass tube and flows over a shaping means, which extends coaxially in the interior of the shaft, in order to determine the inner profile of the glass tube, wherein the shaft extends vertically, the glass melt is cast into the shaft while forming a free meniscus, and the shaping means is cooled, so that the glass melt cools at the latter to a temperature below the softening temperature of the glass and solidifies in the shaft to form the glass tube.

16. The process according to claim 15, wherein the molten glass flows freely into the shaft, so that the shaft is completely filled by the molten glass, at least in sections, in order to determine the outer profile of the glass tube.

17. The process according to claim 15, wherein the molten glass is cast into the shaft at a temperature which corresponds to a viscosity of less than 10^{7.5} dpas, more preferably a viscosity in the range from 10 dPas to 10⁵ dPas and even more preferably a viscosity in the range from 10² dPas to 10⁵ dpas, wherein the molten glass is cooled at the shaping means to below the softening temperature of the glass, so that the glass tube supports the glass melt flowing after into the shaft.

18. The process according to claim 15, in which a gas cushion is formed on an inner circumferential wall of the shaft in order to prevent direct contact between the inner circumferential wall of the shaft and an outer circumferential wall of the glass tube, at least in sections.

19. The process according to claim 18, wherein the gas cushion is formed on the inner circumferential wall of the shaft with an overpressure.

20. The process according to claim 19, in which the overpressure of the gas cushion is adjusted through the inflow of a flushing gas into a pressure vessel holding the shaft.

21. The process according to claim 20, wherein at least one flushing gas outlet of the pressure vessel is at least partly closed in order to develop the overpressure of the gas cushion.

22. The process according to claim 20, in which the flushing gas passes through a circumferential wall, which is porous at least in sections, into the interior of the shaft in order to develop the overpressure of the gas cushion.

23. The process according to claim 15, wherein a coolant flows through the shaping means, which is cooled.

24. The process according to claim 15, in which a flushing gas passes through an outer circumferential wall, which is porous at least in sections, of the shaping means in order to form a form a gas cushion, which is preferably subject to an overpressure, between an inner circumferential wall of the glass tube and an outer circumferential wall of the shaping means and to prevent direct contact between the inner circumferential wall of the glass tube and the outer circumferential wall of the shaping means, at least in sections.

25. The process according to claim 15, further comprising the step of axially lowering a closure element, which is adapted to a shape of the glass tube, and removing the closure element from the shaft after the lowering step.

26. The process according to claim 15, wherein a ratio of outside diameter (OD) to wall thickness (WT) is lower than or equal to 0.1*OD/[mm], wherein OD and WT denote the outside diameter and the wall thickness, respectively, of the glass tube in millimetres, and wherein the outside diameter is greater than or equal to 40 mm.

27. The process according to claim 15, wherein the cast glass tube is used as a preform, and wherein the outside diameter of the cast glass tube is reduced by means of an additional redrawing step.

28. The process according to claim 27, wherein the cast glass tube is clamped in a retaining device, partially heated and then drawn to the desired outside diameter during redrawing.

29. The process according to claim 28, wherein lateral forces act on the glass in the deformation zone during redrawing and give rise to a change in the cross-sectional shape.

30. The process according to claim 29, wherein the lateral forces are applied by one roller or a plurality of rollers.

31. A glass tube, wherein a ratio of outside diameter (OD) to wall thickness (WT) is lower than or equal to 0.1*OD/[mm], wherein OD and WT denote the outside diameter and the wall thickness, respectively, of the glass tube in millimetres, and wherein the outside diameter is greater than or equal to 40 mm.

32. Use of the glass tube according to claim 31 for technical components, in particular electromagnetic components.

33. Use of the glass tube according to claim 31 for producing a further glass tube by redrawing.
